(19) United States
(12) Patent Application Publication
(10) Pub. No.: US 2002/0025822 A1
(43) Pub. Date: Feb. 28, 2002

(54) Resolving ambiguous sector-level location and determining mobile location

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/933,685

(22) Filed: Aug. 20, 2001

Related U.S. Application Data
(60) Provisional application No. 60/226,378, filed on Aug. 18, 2000.

(51) Int. Cl. H04Q 7/20

(52) U.S. Cl. 455/456; 455/457; 455/421; 455/458

(57) ABSTRACT

A mobile station may determine current position information by comparing and processing signals from various base stations. A mobile station may receive one or more parameters such as a PN (pilot pseudo noise offset) that do not uniquely identify base stations. The mobile station may perform calculations to identify the probability the parameters originated at each particular base station. Once the origin of the parameters is obtained, the position information may be derived by triangulation or any of a variety of techniques.

### CROSS-REFERENCE TO RELATED APPLICATIONS

This application claims benefit of U.S. Provisional application No. 60/226,378, filed Aug. 18, 2000, the content of which is herein incorporated by reference in its entirety.

### TECHNICAL FIELD

This invention relates to wireless communication systems, and more particularly to determination of position information of a mobile station.

### BACKGROUND

The use of wireless communication systems is growing with users now numbering well into the millions. One of the most popular wireless communications systems is the cellular telephone, consisting of a mobile station (or handset) and a base station. Cellular telephones allow a user to talk over the telephone without having to remain in a fixed location. This allows users to, for example, move freely about the community while talking on the phone.

In some systems, position information of the mobile station may be used to enhance the services provides to the user. However, the position of the mobile station may not be easily obtained in some systems. If a mobile station is aware of its position information, this data may be communicated back to the base station. The mobile station may report the position information upon request of the wireless network, or may be programmed to report the position information at a specific time interval or upon a particular change in position information. However, not all mobile stations or systems have the capability of easily determining position information. What is needed is a technique for obtaining the position information of mobile stations from received data in a wireless communication system.

### SUMMARY

A mobile station may determine the current position information by comparing and processing signals from various base stations. A mobile station may receive one or more parameters such as a PN (pilot pseudo noise offset) and compare the parameters with known parameters from various base stations. The mobile station may perform calculations to identify the probability the parameters originated at each particular base station. Once the origin of the parameters is obtained, the position information may be derived by triangulation or any of a variety of techniques.

### DESCRIPTION OF DRAWINGS

These and other features and advantages of the invention will become more apparent upon reading the following detailed description and upon reference to the accompanying drawings.

FIG. 1 illustrates the components of an exemplary wireless communication system used by one embodiment of the present invention.

FIG. 2 is a block diagram showing features of a mobile station according to one embodiment of the invention.

FIG. 3 is a flowchart illustrating a process for determining position information of the mobile station according to one embodiment of the invention.

### DETAILED DESCRIPTION

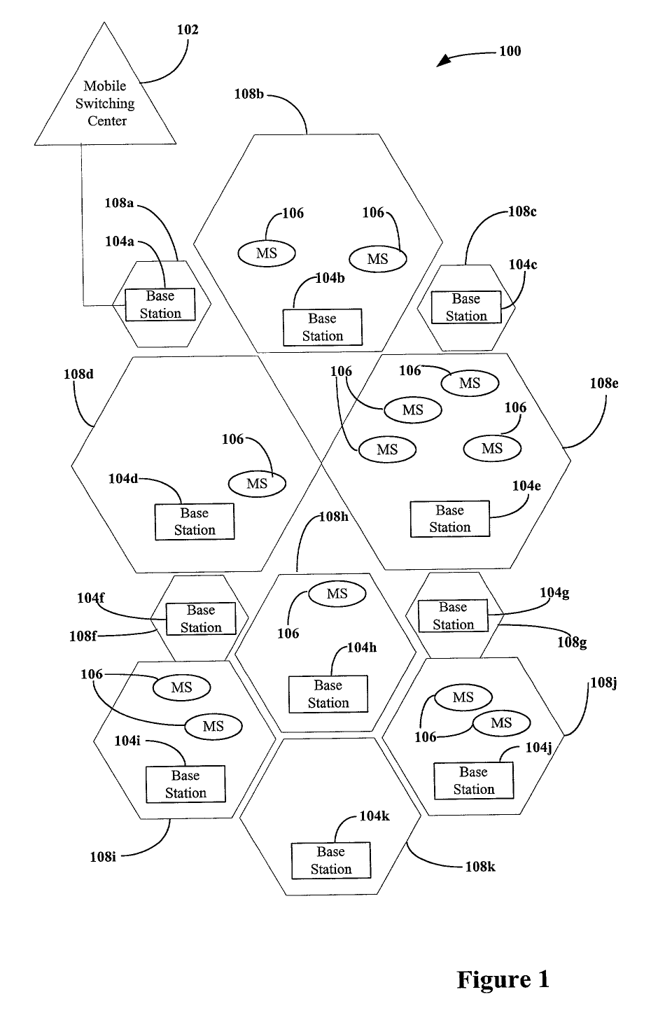

FIG. 1 illustrates components of an exemplary wireless communication system 100. A mobile switching center 102 communicates with base stations 104a-104k (only one connection shown). The base stations 104a-104k (generally 104) broadcasts data to and receives data from mobile stations 106 within cells 108a-108k (generally 108). The cell 108, corresponding to a geographic region, is served by a base station. Practically, said geographic regions often overlap to a limited extent.

A mobile station 106 is capable of receiving data from and transmitting data to a base station 104. In one embodiment, the mobile station 106 receives and transmits data according to the Code Division Multiple Access (CDMA) standard. CDMA is a communication standard permitting mobile users of wireless communication devices to exchange data over a telephone system wherein radio signals carry data to and from the wireless devices. A set of standards that define a version of CDMA that is particularly suitable for use with the invention include IS-95, IS-95A, and IS-95B, Mobile Station-Base Station Compatibility Standard for Dual-Mode Spread Spectrum Systems; TIA/EIA/IS-2000-2, Physical Layer Standard for cdma2000 Spread Spectrum Systems; and TIA/EIA/IS-2000-5 Upper Layer (Layer 3) Signaling Standard for cdma2000 Spread Spectrum Systems, all of which are herein incorporated by reference in their entirety.

Under the CDMA standards, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

When detecting a call, the cellular telephone scans data frames transmitted by the base station 104 to detect any telephone calls or paging messages directed to the cellular telephone. In this call detection mode, the cellular telephone receives, stores and examines paging message data, and determines whether the data contains a mobile station identifier matching an identifier of the cellular telephone. If a match is detected, the cellular telephone establishes a call with the mobile switching center 102 via the base station 104. If no match is detected, the cellular telephone enters an idle state for a predetermined period of time, then exits the idle state to receive another transmission of paging message data.

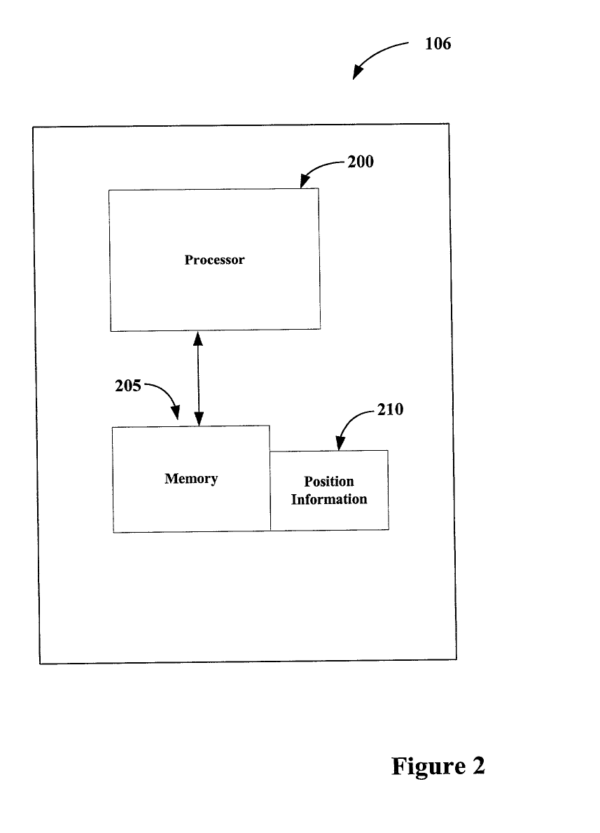

FIG. 2 shows a block diagram of the mobile station 106 and the processing that occurs in that mobile station 106. The processor 200 is driven by a program stored in a memory 205.

The mobile station 106 may obtain information regarding the current position of the mobile station 106. This information may be obtained from a variety of sources, including global positioning, triangulation between base stations, internal calculations or any other method. A memory 210 may store various conditions including the current position information.

The present invention provides a means to figure out which base stations correspond to which ambiguous parameters reported by a mobile station. For example, a mobile station may obtain Pilot Pseudo Noise (PN) offset information. However, PNs are re-used in CDMA systems and may not uniquely correspond to base stations, i.e. multiple base stations may use the same PN. In order to determine a mobile stations location relative to a base station, the ambiguity may have to be resolved. The present invention resolves this ambiguity. This ambiguity may arise in location processing such as Advanced Forward Link Trilateration (AFLT) where pilot PN phases are used to determine mobile position. While a PN may not uniquely identify which base station the mobile is receiving a signal from, the neighboring PNs, PNs in a neighbor list that is broadcast by the network, active or candidate PNs may be used to figure out which base station likely corresponds to that PN. This is particularly effective when, for example, two base stations use the same PN but the neighbor base stations of those two use different PNs and hence can be used in the process of identification. The process of resolving the ambiguity may be done at a position determination entity, at a server, at the mobile station or at any other network entity.

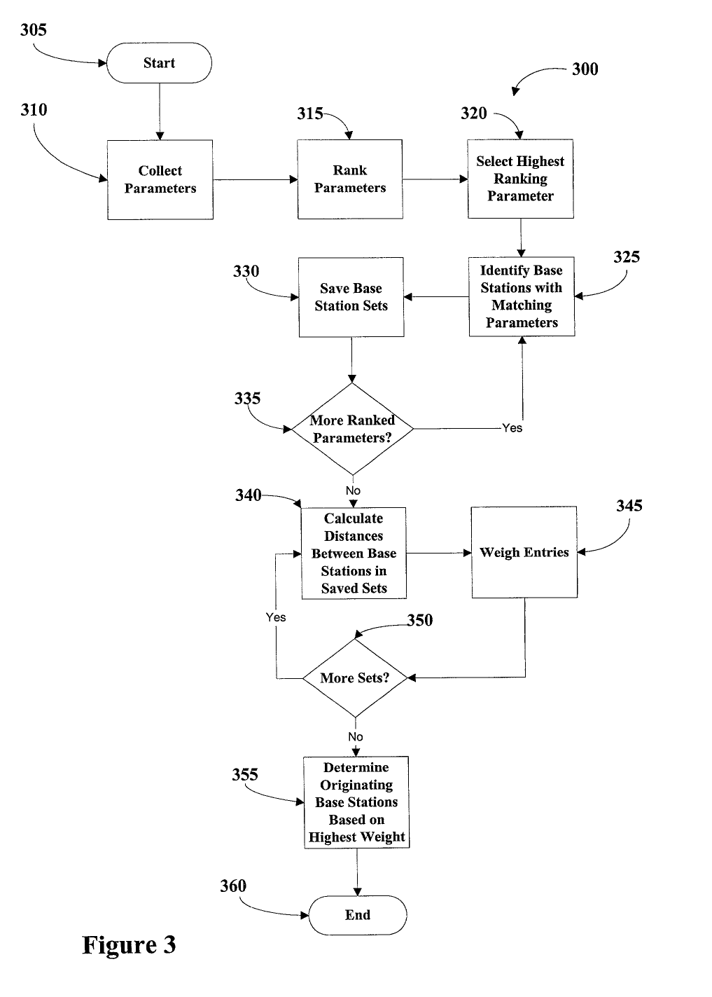

FIG. 3 is a flowchart illustrating a process 300 for determining the position of the mobile station 106. The process 300 begins at a start block 305. Proceeding to block 310, the process 300 collects parameters such as the pilot PN offset. The pilot PN offset is used to distinguish sectors in a CDMA system. Although the present invention is described using the pilot PN offset, it can be appreciated the invention may be performed using any of a variety of parameters.

Proceeding to block 315, the PNs that were input to the system are ranked according to a weight (the weight may be, for example, PN phase offset, Ec/Io energy, etc . . . ). The weight for PN(i) be denoted Wᵢ.

Proceeding to block 320, the highest ranking parameter of block 315 is selected. The process then proceeds to block 325, where the highest ranking parameter is used to identify all entries in a base station database (which has entries correlating base station PNs with each base station or vice versa) with a matching parameter. The base station database also includes location data (latitude and longitude) and optionally may contain sector direction information as well as other location related data for each base station. Although each base station may have a number of sectors and therefore a number of associated pilot PN offsets, the process 300 only requires that one of the base station's PNs match the given PN.

Proceeding to block 330, the set of identified base stations with matching entries is saved. This set may be assigned a designation such as L(0).

Proceeding to block 335, the process 300 determines if more ranked parameters are present. If more ranked parameters are present, the process 300 proceeds along the YES branch back to block 325 to process the next highest ranking parameter (PN). This next highest ranking parameter may be designated as PN(i). In block 325, the database is again searched for base station entries with matching PN, and the results are saved in block 330 as set L(i).

Returning to block 335, after all the ranked parameters are processed, the process 300 proceeds along the NO branch to block 340. In block 340, the distances between each of the base stations in the saved sets are calculated. The distance from each entry in set L(0) to each entry in set L(i) is calculated. The process 300 may denote the distance from base station n in set L(0) to base station m in set L(i) as d_{i,O}(n,m). In some circumstances, the distance may be 0 because the two PN's correspond to sectors of the same base station.

Proceeding to block 345, each of the distance calculations between entries in L(i) and L(j), where-upon the first time proceeding through block 345 j equals 0, is given a weight. These weights will be used in determining a score for associating an originating base station with a specific parameter value such as a PN. A weight W_{i,O}(n,m) is calculated based on, or by combining, one or more of the following a) d _{i,O}(n,m), b) the weight Wᵢ, c) how correlated the phase offset between the two PNs corresponds to the distance or area, and d) the direction the sectors face (i.e. away from one another, toward one another, same direction, etc.) The weight provides a measure of how likely it is that the two base stations (possibly one and the same) are the ones corresponding to the PNs that the mobile is seeing. The weight should indicate a stronger relationship, for example, if the distance is shorter and the phase offset is correlated closely with the distance. In the preferred embodiment, the weight is inversely proportional to the geometric distance between base stations and the Wᵢ parameter is multiplied by the distance in the process of determining the weight. If Wᵢ is high, then the weight should be stressed (i.e. weaker if it is weak, and stronger if it is strong). Otherwise, if Wᵢ is low, then the weight should be de-emphasized.

Proceeding to block 350, the process 300 determines if any more saved base station sets are available. The processing of additional parameters and the sets corresponding to each parameter is optional, and the process 300 may proceed to block 355. The decision in block 350 determines if there are more parameters. If there are more parameters, then the process 300 proceeds along the YES branch back to block 340 to repeat the comparison and weighting with the next highest ranking parameter, for example, PN(i). If all the PNs have been processed, the process 300 proceeds along the NO branch to block 355. Alternatively, the process may repeat only until a desired level of confidence is reached, a predetermined number of parameters are processed, or the highest scoring solution is better than the next highest scoring solution by a predetermined amount.

The present invention includes performing an optional step stemming from block 340. If the optional step is performed, it may involve up to (i−2) distance calculation operations, each timereplacing 0 in L(0) by j, where j runs from 1 to (i−1). The optional operations may depend on the level of precision, accuracy or integrity desired. These operations may be performed depending on the level of desired precision, accuracy, or integrity. For example, this optional step can be used to incorporate the distances between base stations of non-highest ranking PNs. These results can be incorporated into the score of those base-station-PN pairs.

In block 355, the originating base stations corresponding to each parameter (PN for example), is determined based on the highest weighted entries in each list L(i). The process 300 finds the highest scoring set of specific originating base stations. This is the solution. The score for a hypothesis of particular combination of originating base stations may be computed as the sum of the weights for each originating base station. For example, in the case where there are only 2 parameters (say 2 PNs), the score is not a sum but rather comprises one weight representing the combination of originating base station for the first parameter and originating base station for the second parameter. This step is done in block 345. Alternatively, the scoring can be done on-the-fly by keeping a score in block 340 as the computations are done. A running score can be kept for each possible originating base station and PN, for example, by adding newly calculated weights. The solution consists of a number of specific base stations identified in the highest ranking solution that have the respective PN's. There are a number of ways to select these base stations. In one example, the solution (base station) for each PN is an entry in the list corresponding to that PN. Specifically, it is the entry with that contributed to the highest scoring base station in L(0). Another example is to select the base station in each list with the highest score. Once the solution is obtained, the process 300 terminates in END block 360.

An example of one embodiment of the present invention is as follows:

Base Station 1 (BS1) has a location (10,10) and has sectors with PNs: 12, 24, 48

Base Station 3 (BS3) has a location (100,100) and has sectors with PNs: 12, 220, 200 Base Station 4 (BS4) has a location (110,110) and has sectors with PNs: 100, 400, 444

The mobile station 106 sees PNs 12, 100 (12 is received stronger than PN 100). The algorithm proceeds by searching for PN 12 and finds two base stations with that PN, thus L(0)=BS 1 and BS 3. The algorithm then proceeds by searching for PN 100 and finds only one base station with that PN, thus L(1)=BS 4. The distance from BS 1 to BS 4 is further than that from BS 3 to BS 4. BS 3 in L(0) is given a higher weight than BS 1. Therefore the algorithm selects BS 3 as the solution for PN 12 and BS 4 as the solution for PN 100. Now that the system has identified which base stations correspond to the PN offsets reported by the mobile, it can triangulate (by search or computation) the location of the mobile station 106 using PN phase offset strength, Ec/Io, or other measure. In place of triangulation, the system may use a simplification to approximate or estimate the mobile location in a faster (less computationally intensive manner). For example, the system can simply use the average of (latitude, longitude) of all the base stations as the estimate of the mobile's location.

Numerous variations and modifications of the invention will become readily apparent to those skilled in the art. Accordingly, the invention may be embodied in other specific forms without departing from its spirit or essential characteristics.

What is claimed is:

1. A method of determining position information in a wireless information system comprising:
comparing parameter information;
identifying parameter origination information; and
determining position information from the origination information.

2. The method of claim 1, further comprising determining the position information using triangulation.

3. The method of claim 1, further comprising identifying a base station which transmitted the parameter information.

4. The method of claim 1, further comprising identifying the parameter information as pilot pseudo noise offset.

5. The method of claim 1, further comprising identifying the parameter origination information using a weighted system.

6. The method of claim 1, further comprising comparing a plurality of parameter information.

7. The method of claim 1, further comprising correlating the parameter information to a specific base station.

8. A method of determining position information for a mobile station in a wireless information system comprising:
collecting a plurality of pilot pseudo noise offsets; and
identifying a base station for each of the plurality of pilot pseudo noise offsets by evaluating that said identification is consistent relative to the other pilot pseudo noise offsets.

9. The method of claim 8, further comprising ranking each pilot pseudo noise offset.

10. The method of claim 9, wherein said ranking of each pilot pseudo noise offset uses a parameter selected from the group consisting of pilot pseudo noise phase, pilot energy, and ratio of pilot chip energy to interference.

11. The method of claim 8, further comprising solving for the position information using the base station identities.

12. The method of claim 8, wherein said evaluating that said identification is consistent relative to the other pilot pseudo noise offsets further comprises searching a database for all base stations having a pilot pseudo noise offset equal to a first pilot pseudo noise offset in said plurality of pilot pseudo noise offsets to form a first list.

13. The method of claim 12, further comprising searching the database for all base stations with a pilot pseudo noise offset equal to a second pilot pseudo noise offset in said plurality of pilot pseudo noise offsets to form a second list.

14. The method of claim 13, further comprising calculating the distance from each base station in said first list to each base station in said second list.

15. The method of claim 14, further comprising modifying the distances by a weighting factor.

16. The method of claim 15, wherein said weighting factor is selected from the group consisting of said distance, a pilot pseudo noise offset weighting factor, a phase offset, and a sector antenna angle.

17. The method of claim 13, further comprising comparing distances between base stations in said base station lists.

18. The method of claim 13, further comprising weighting the entries in the base station lists.

19. The method of claim 13, wherein said database is located in the memory of an network entity selected from the group consisting of said mobile station, a base station, a server, and a position determination entity.

20. The method of claim 8, further comprising solving for the position of the mobile station.

21. The method of claim 8, further comprising averaging the base station locations.

22. A method of determining position information for a mobile station in a wireless information system comprising:
collecting a plurality of parameters related to identification of network entities; and
identifying a network entity for each of the plurality of parameters by evaluating that said identification is consistent relative to the other parameters.

23. The method of claim 22, further comprising ranking each parameter.

24. The method of claim 23, wherein said parameter is selected from the group consisting of pilot pseudo noise phase and pilot pseudo noise offset.

25. The method of claim 22 further comprising solving for the position information using the identification information.

26. The method of claim 22, wherein said evaluating that said identification is consistent relative to the other parameters further comprises searching a database for all network entities having a parameter equal to a first parameter in said plurality of parameters to form a first list.

27. The method of claim 26, further comprising searching the database for all network entities with a parameter equal to a second parameter in said plurality of parameters to form a second list.

28. The method of claim 27, further comprising calculating the distance from each network entity in said first list to each network entity in said second list.

29. The method of claim 28, further comprising modifying the distances by a weighting factor.

30. The method of claim 29, wherein said weighting factor is selected from the group consisting of said distance, a pilot pseudo noise offset weighting factor, a phase offset, and a sector antenna angle.

31. The method of claim 27, further comprising comparing distances between network entities in said network entity lists.

32. The method of claim 27, further comprising weighting the entries in the network entity lists.

33. The method of claim 27, wherein said database is located in the memory of a network entity selected from the group consisting of said mobile station, said network entity, a base station transceiver, a base station controller, a server, and a position determination entity.

34. The method of claim 22, further comprising solving for the position of the mobile station.

35. The method of claim 22, further comprising averaging the network entity locations.

36. A mobile station position locator in a wireless information system comprising:
memory which collects a plurality of pilot pseudo noise offsets; and
a processor which identifies a base station for each of the plurality of pilot pseudo noise offsets by evaluating that said identification is consistent relative to the other pilot pseudo noise offsets.

37. The mobile station position locator of claim 36, further comprising ranking each pilot pseudo noise offset.

38. The mobile station position locator of claim 37, wherein said ranking of each pilot pseudo noise offset uses a parameter selected from the group consisting of pilot pseudo noise phase, pilot energy, and ratio of pilot chip energy to interference.

39. The mobile station position locator of claim 36, further comprising software which solves for the position information using the base station identities.

40. The mobile station position locator of claim 36, wherein the processor further searches a database for all base stations having a pilot pseudo noise offset equal to a first pilot pseudo noise offset in said plurality of pilot pseudo noise offsets to form a first list.

41. The mobile station position locator of claim 40, wherein the database is searched for all base stations with a pilot pseudo noise offset equal to a second pilot pseudo noise offset in said plurality of pilot pseudo noise offsets to form a second list.

42. The mobile station position locator of claim 41, wherein the distance is calculated from each base station in said first list to each base station in said second list.

43. The mobile station position locator of claim 42, wherein the distances are modified by a weighting factor.

44. The mobile station position locator of claim 43, wherein said weighting factor is selected from the group consisting of said distance, a pilot pseudo noise offset weighting factor, a phase offset, and a sector antenna angle.

45. The mobile station position locator of claim 41, wherein the processor compares distances between base stations in said base station lists.

46. The mobile station position locator of claim 41, wherein the processor weights the entries in the base station lists.

47. The mobile station position locator of claim 41, wherein said database is located in the memory of an network entity selected from the group consisting of said mobile station, a base station, a server, and a position determination entity.

48. The mobile station position locator of claim 36, wherein the processor solves for the position of the mobile station.

49. The mobile station position locator of claim 36, wherein the processor averages the base station locations.

50. A mobile station which determines position information in a wireless information system comprising:
storage elements which collect a plurality of parameters related to identification of network entities; and
a processor which identifies a network entity for each of the plurality of parameters by evaluating that said identification is consistent relative to the other parameters.

51. The mobile station of claim 50, wherein the processor ranks each parameter.

52. The mobile station of claim 51, wherein said parameter is selected from the group consisting of pilot pseudo noise phase and pilot pseudo noise offset.

53. The mobile station of claim 50, wherein the processor solves for the position information using the identification information.

54. The mobile station of claim 50, wherein the processor searches a database for all network entities having a parameter equal to a first parameter in said plurality of parameters to form a first list.

55. The mobile station of claim 54, wherein the processor searches the database for all network entities with a parameter equal to a second parameter in said plurality of parameters to form a second list.

56. The mobile station of claim 55, wherein the processor calculates the distance from each network entity in said first list to each network entity in said second list.

57. The mobile station of claim 56, wherein the processor modifies the distances by a weighting factor.

58. The mobile station of claim 57, wherein said weighting factor is selected from the group consisting of said distance, a pilot pseudo noise offset weighting factor, a phase offset, and a sector antenna angle.

59. The mobile station of claim 55, wherein the processor compares distances between network entities in said network entity lists.

60. The mobile station of claim 55, wherein the processor weights the entries in the network entity lists.

61. The mobile station of claim 55, wherein said database is located in the memory of a network entity selected from the group consisting of said mobile station, said network entity, a base station transceiver, a base station controller, a server, and a position determination entity.

62. The mobile station of claim 50, wherein the processor solves for the position of the mobile station.

63. The mobile station of claim 50, wherein the processor averages the network entity locations.
